(19) United States
(12) Patent Application Publication
(10) Pub. No.: US 2003/0170428 A1
(43) Pub. Date: Sep. 11, 2003

(54) Overwrapping film and method of use

(76) Inventor: Rickie A. Willis, Miamisburg, OH (US)

Correspondence Address: David M. FrischKorn, McDonnell Boehnen Hulbert & Berghoff, 32nd Floor, 300 S. Wacker Drive, Chicago, IL, 60606, US

(21) Appl. No.: 10/093,181

(22) Filed: Mar. 7, 2002

(51) Int. Cl. B32B 3/00

(52) U.S. Cl. 428/195.1

(57) ABSTRACT

The instant invention provides a multi-layered film composite for overwrapping consumer goods wherein a printed surface is sandwiched between the layers such that it does not inhibit or obliterate the self-sealing property of the films making up the composite. Also disclosed is a method of manufacturing an overwrap film composite that allows for complete printed film coverage.

### FIELD OF THE INVENTION

The present invention relates to a process and method of manufacture of shrink-wrap packaging, and more particularly, relates to a composite film having at least two-plys where a printed surface is sandwiched between two films. My invention also is directed to a wrapping process that allows for complete film printing.

### BACKGROUND OF THE INVENTION

Many consumer goods are packaged in a low cost heat-shrinkable overwrap film prior to shipment. Examples include the plastic covering CD jewel cases and cigarette packs. Such overwrap film is used mainly for product protection while in transit and on display at retail stores. At the appropriate time, the overwrap film is easily removed by the end-user and then simply discarded. Thus, overwrap film offers a less expensive alternative to traditional packaging (e.g., cardboard boxes, paper cartons, thick plastic cases, etc) that is typically used to protect consumer goods. A special property of overwrap film is its ability to seal or stick to itself. This self-sealing property is imparted to the film either during manufacture of the film or as a special chemical treatment after the film is formed. Regardless of how the self-sealing property is imparted to the film, the self-sealing property is critical to obtaining a high quality wrapped product.

Besides acting as a protective barrier for the goods enclosed, overwrap film is also useful for advertising purposes. Price tags, stickers, and/or other adhesive labels can be placed directly on the overwrap film without damaging the product. Thus, one outcome to this disposable barrier is that consumer goods can be produced without the presence of price markings, thereby allowing vendors to label the goods with their own prices.

Another advantage of the overwrap film is its use in product identification and placement of promotional information. As opposed to other methods of packaging, the clear, see-through characteristic of the overwrap film allows for easy visualization of the product while on display. Advertising's desire for more billboard spaces, however, has expanded the film's usefulness to new areas. There exist single-ply overwrap films (like those used currently to wrap blank CD) that have preprinted product information such as the producer's name, logo and/or other advertisements, however, these single-ply overwraps suffer in that the ink from the printed material inhibits the wrap from sealing (or sticking) to itself and therefore results in a poorly wrapped product. To avoid this disadvantage the single-ply overwrap must be printed with a special printing procedure that allows ensures that no ink is located on the film where it is folded onto itself to allow it seal or stick together. Without this special printing procedure, the ink would obliterate or drastically inhibit the self-sealing property of the film. Thus, ineffective sealing of the overwrap film will take place along the seams if ink is present in these locations and result in a poorly wrapped product. Because location of the ink during printing is limited, advertising design space is therefore diminished because the packaging film must have at least the sealable portion devoid of ink. Likewise, the special printing process adds complexities and higher finished film manufacturing cost.

My invention solves the above-mentioned problems by incorporating the printed ink within at least two layers of film such that the outside surfaces of the resultant finished film are ink-free and can be easily sealed during product wrapping. Moreover, my invention provides a process for manufacturing overwrap film that allows for complete ink coverage of the film, thereby maximizing its available billboard advertising space.

### SUMMARY OF THE INVENTION

As stated, my invention is directed to an improved overwrap film and method of manufacturing an overwrap film that has complete ink coverage, and that further avoids the current requirement of having inkless seams for sealing. My invention is also directed to an improved method of wrapping products with at least two-plys of overwrap film. A further advantage of my process is that the overwrap film provides a better protective barrier, compared to the current state of the art of a single-ply overwrap, since my invention consists of a multi-layered overwrap made by combining at least two rolls of film.

In general, the overwrap film of my invention consists of a multi-layered packaging film that has ink imbedded in an inner layer. This manufacturing design allows for effective shrink-wrapping and sealing since it eliminates the problems associated with trying to heat-seal directly on an inked surface. In particular, the multi-layered packaging overwrap of my invention covers a composite film having a first film with an inner and outer surface, where either surface is possess a self-sealing property imparted as a chemical treatment, inherent in the manufacture of the raw film or a combination of both. The self-sealing property is necessary so the film can stick to itself during a sealing process. Ink is printed on at least one inner surface of at least one of the films used to form the multi-layered composite. The composite also contains at least a second self-sealing film having two surfaces and where one of the surfaces is in contact with the inked inner surface of the first film to form a composite multi-layered packaging overwrap.

The process for manufacturing my multi-layered packaging overwrap comprises printing ink on the inner surface of a first roll of self-sealing film, thereby forming a printed first roll of treated film and then using a second roll of self-sealing film to cover the inked surface of the first roll of film, thereby forming a composite multi-layered packaging overwrap.

The overwrap composite of my invention can be used to cover a wide variety of packages. In general, my process for overwrapping a package comprising providing a roll of multi-layered packaging overwrap film roll having pre=printed inked surface sandwiched between at least two layers of self-sealing film. Unrolling and registering the composite film, cutting the film to an appropriate size to fit the package, placing the outside, non-inked surface of the film in contact with a package, and wrapping the package.

### BRIEF DESCRIPTION OF THE DRAWINGS

FIG. 1 is a schematic diagram of the multi-layered overwrap of my invention.

FIG. 2 is a schematic diagram of a method of manufacturing the multi-layered overwrap of the present invention.

### DETAILED DESCRIPTION OF THE INVENTION

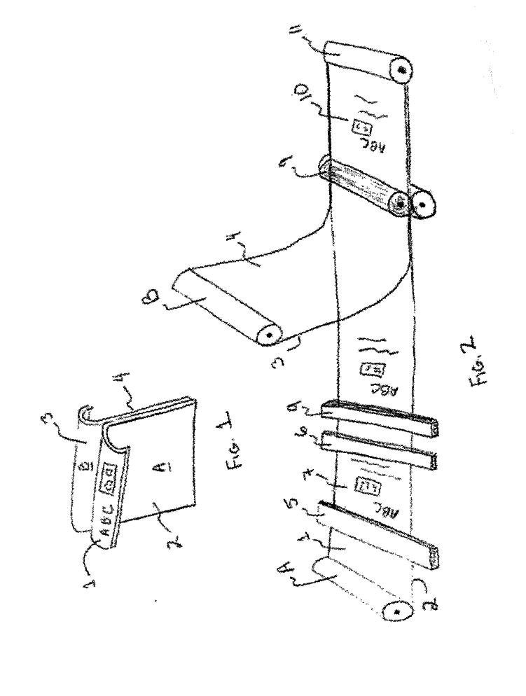

The film layers that make up my invention can be any type or combination of packaging film known to the art, preferably those films that are made using any of the following well known chemical compositions: cellulose nitrate, cellulose acetate, polyethylene, polystyrene, poly(vinyl chloride), poly(acrylate), poly carbonate, polyolefin, polyamide, polyimide, and poly(arylketone). A preferred film type is commonly referred to as shrink-wrap and includes PVC, polyethylene, polypropylene and mixtures thereof. A most preferred film is one that is made of polypropylene and that is chemically coated with an acrylic to impart a self-sealing property. In particular, a preferred film is an 80-gauge film sold by Exxon Mobil under the trade name TYTE. Although my invention can be made using different films, one requirement of my invention is that at least the outermost surfaces of the resultant multi-layered film composite possess the self-sealing property. As previously mentioned, in order to obtain a good quality wrap on a product, the film must be capable sticking to itself when heat and pressure are applied. This ability to self-adhere is either inherent in the starting film because certain materials are added during the manufacturing process or it is imparted to the film after manufacture through application of a chemical treatment to the film surface. Typically, the chemical treatment involves coating the film surface with a resin having a lower melting point than the polymer used to fabricate the film. As illustrated in FIG. 1, the multi-layered overwrap of my invention comprises at least two films laminated together. Film A has an inner surface 1 and outer surface 2. Inner surface 1 contains printed information, such as text, graphics, designs, or pictures. Film B, having surfaces 3 and 4, is laminated with Film A through the use of an adhesive. The preferred waterbased adhesive is one sold by Ashland Chemical Company and is designated as #4001 with catalyst #1004 and is applied to one or both surfaces prior to joining surface 1 to surface 3, however, the particular adhesive chosen is not critical to my invention. In other words, any adhesive known to the art for laminating films can be used. Because the printed surface of Film A is covered by Film B, the resultant composite can be folded and sealed by joining surface 2 of Film A with surface 4 of Film B. Likewise, because there is no printed material on either surface 2 or 4, there is no obliteration of the self-sealing property and as such, good sealing is possible along all surfaces of surface 2 or surface 4. Lamination of Film A with Film B can be accomplished by the various methods known to the art, including heated rollers, compression rollers and through combinations of heating and pressure application. Once Film A and Film B are laminated together, the outside surfaces 2 and 4 are ink-free and can bond together when folded on itself when the composite film is used as a over-wrap for the product. Although FIG. 1 illustrates the combination or lamination of only two films, my invention also covers the lamination of two or more films, provided that all printed or inked surfaces are not located on either of the resulting outer surfaces, which would inhibit sealing during the over-wrapping process.

Referring now to FIG. 2, which illustrates one possible method of manufacturing the multi-layered film of my invention. The first step of the process involves obtaining at least two film rolls commercially available for use as shrink wrapping consumer products, such as the film typically used to wrap CD jewel cases, cigarette packs, and other goods. Next, Film A is used in a printing process to apply text, graphics or other images (color or black and white) to surface 1 of Film A. The specific printing technique used is not critical to my invention and any known printing process may be used.

Preferably a nine-color printing technique is used. It is desirable, however, that the printing process incorporates a registering step, where pre-selected registration marks or images are printed on inner surface 1 during the printing process. These registration marks are then used in a subsequent registering process, in combination with a timing device and electronic eye, to insure proper alignment of the finished composite multi-layered film during the cutting and over-wrapping processes. The timing device works in conjunction with the electronic eye and is used to speed up or slow down the film speed during the cutting and wrapping process. The electric eye is continually looking for the registration marks. If the registration marks arrive too early or too late, the eye detects the situation and sends a signal to a servo motor (part of the timing device) telling it to speed up or retard as needed allowing the film to be cut to an accuracy of ≠1/32 of an inch consistently. The registering process allows the printed film to be properly aligned with the product being wrapped. For example, in the packaging of a music CD jewel case, it is very important to align the printed spine label, containing the title and artist name, so that it fits along one of the narrow ends of the jewel case. Likewise, the registering process insures the text and graphics are squared and centered on the product.

After printing on one surface of Film A, an adhesive is applied to the printed surface using applicator 6. The particular adhesive used or the design of applicator 6 is not critical to my invention, provided that it does not detrimentally affect the quality of the printed surface. Preferably, a water-based adhesive is used. The adhesive can be applied to the printed surface or to blank Film B used to laminate printed Film A. Once the adhesive is applied, it is preferable to run Film A through heated oven 8 to dry and cure the adhesive.

After applying the adhesive, Film B is then laminated to Film A so that surface 1 is placed in contact with surface 3. This results in the printed matter being buried on the inside of the laminated composite. Depending on the orinintation of the printed material, it is preferable that Film B be transparent so the printing shows through it. Alternatively, Film A can be transparent if the pinting is oriented in the opposite direction. Of course, both films can be transparent as well. The lamination process is performed using any known combinations of pressure and/or temperature. A preferred method involves the use of nip rollers 9. The nip rollers apply pressure to ensure a good lamination. Heat may be used during lamination by heating one or more of the nip rollers or by using an external heat source such as forced air, IR, or other means. Of course, in the situations where more than two films are to be laminated, then the lamination process is repeated. After lamination the composite film 10 is wound on take-up roll 11 and eventually transported to and/or directly used, in the over-wrapping process. The finished multi-layered film 10 can be used directly with a standard over-wrapping apparatus, such as the CD wrapping machines sold by the Scandia Packaging Machinery Company. In particular, the Scandia Model 600 series is pretreated. In fact, my finished film composite can be used in any apparatus normally used for over-wrapping or packaging consumer goods. Preferably, the over-wrapping process utilizes my registering process as described above, wherein a standard over-wrapping apparatus is modified with an electronic eye and timing device to control the speed and accuracy of the wrapping process.

As one skilled in the art will appreciate, the particular type of starting film, adhesives or ink is not critical to my invention. My invention lies with the unique composite film layering and the discovery of using this composite in shrink-wrapping to achieve complete ink coverage. While we have described what we believe are preferred embodiments of the invention, those skilled in the art will recognize that other and further modifications may be made thereto (e.g., to adapt the invention to various conditions, types of film, types of ink, or other requirements) without departing from the spirit of my invention as defined by the following claims.

We claim:

1. A multi-layered packaging overwrap comprising,
a. a first self-sealing film having an inner and outer surface, where ink is printed on the inner surface;
b. a second self-sealing film having two surfaces and where one of the surfaces is in contact with the inner surface of the first film forming a laminate of the first and second films and resulting in a composite multi-layered packaging overwrap.

2. The overwrap of claim 1 wherein an adhesive is used between the first and second films to form a bond such that the printed ink on the inner surface of the first film is in contact with one of the surfaces of the second film.

3. The overwrap of claim 1 where the second film is completely transparent.

4. The overwrap of the claim 1 where the second film does not obscure reading or viewing of the printed ink on the inner surface of the first film.

5. The overwrap of the claim 1 where the first and second films are laminated with at least one additional self-sealing film.

6. A process for manufacturing a multi-layered packaging overwrap, comprising, in combination,
a. providing a first roll of self-sealing film having an inner and outer surface;
b. providing a second roll of self-sealing film having two surfaces;
c. printing with ink on the inner surface of the first film;
d. joining the first film with the second film such that inner surface of the first film is in contact with one of the surfaces of the second film; and
e. laminating the joined films to form a composite multi-layered packaging overwrap.

7. The method of claim 6 further characterized in that an adhesive is applied to either the first or second film prior to joining.

8. The method of claim 6 further characterized in that the laminating step includes pressing the first and second films together to form the composite.

9. The method of claim 8 further characterized in that the laminating step is accomplished by simultaneously feeding the first and second films to nip rollers.
